(19) United States
(12) Patent Application Publication
(10) Pub. No.: US 2002/0195044 A1
(43) Pub. Date: Dec. 26, 2002

(54) Signalling apparatus for restaurant service

(76) Inventor: Timothy John Hayward, Darwin Nt (AU)

Correspondence Address: SHOEMAKER AND MATTARE, Suite 1203, 2001 Jefferson Davis Highway, Arlington, VA, 22202-0286, US

(21) Appl. No.: 10/173,982

(22) Filed: Jun. 19, 2002

(30) Foreign Application Priority Data
Jun. 21, 2001 (AU) 2001100104

(51) Int. Cl. G09F 17/00; G09F 19/00

(52) U.S. Cl. 116/173; 116/325

(57) ABSTRACT

Signalling apparatus (10) for use in restaurants or other establishments for attracting the attention of staff including a stand (11) which can seat upon a table or other supporting surface and which has first lower opening (15) and a second elevated opening (16) for receiving an elongated member (17) which carries at its upper end, a display card (23) which may be supported for free rotation to the member (17). The elongated member (17) when supported in an upright attitude in the elevated opening can attract the attention of staff.

### TECHNICAL FIELD

This invention relates to signalling apparatus and in a particular aspect to apparatus for use in restaurants or other like establishments to signal that attention or service from staff of the restaurant or like establishment is required.

### BACKGROUND ART

A common problem encountered in restaurants or other establishments providing food and/or beverages, particular in alfresco dining establishments, is that of attracting the attention of staff such as waiters or food attendants say for the purchase of food or beverages, payment of bills or for other purposes. Usually patrons attempt to attract waiters or other staff by waving of hands, or by verbal means. This is often unsuccessful and can be embarrassing to the patron.

### SUMMARY OF THE INVENTION

The present invention aims to provide a simple and effective signaling apparatus which may be used to attract attending staff in restaurants or other like establishments particular alfresco establishments. The present invention in a further aspect aims to provide signaling apparatus which may also be used for carrying advertising material. Other objects and advantages of the invention will become apparent from the following description.

The present invention thus provides in one aspect, signaling apparatus for use in restaurants or other establishments for attracting the attention of staff, said signaling apparatus comprising:

a signaling device;

a stand adapted to seat upon a table or other supporting surface, said stand having first and second locating means for said signaling device, one said locating means being elevated relative to the other said locating means,

whereby placement of said signaling device at said one locating means indicates that attention of staff is required

Preferably, the signaling device comprises an elongated member, and the locating means comprise means for supporting the elongated member in an upright attitude. Suitably, the locating means comprise holes or apertures in the stand for receiving a lower end of the elongated member.

The elongated member may be provided at its upper end with display means which may serve as the or an additional means to attract the attention of staff. The display means however may also carry advertising information such as advertising material relating to a particular food or beverage such as a wine. Most preferably, the display means is mounted rotatably at the upper end of the elongated member so as to be capable of free rotation about a substantially vertical axis. The display means suitably comprises a holder which releasably holds a planar display member such as a display card.

The holder may comprise a cylindrical body, the body having at one end a diametrically extending slit for receipt and support of the planar display member. The holder suitably includes a hollow socket for location over the upper end of the elongated member so that the holder is supported for rotation relative to the elongated member.

Means may be provided for capturing the holder to the upper end of the elongated member. The capturing means may comprises a groove suitably an annular groove in the one end of the elongated member and restraining means such as a flexible washer extending from the bolder into the groove to restrain detachment of the holder from the elongated member.

The support stand may include a generally planar base which has one aperture or hole defining the other locating means to receive and support the elongated member in a lowered position, and a tower-like portion supported on or extending from the base which also has an aperture or hole defining the one locating means to receive and support the elongated member at an elevated position.

In a further aspect, the present invention provides signaling and advertising apparatus for use in food or drink establishments, said apparatus comprising:

a signaling and advertising device, said signaling and advertising device having means for displaying advertising material;

a stand adapted to seat upon a table or other supporting surface, said stand having first and second locating means for said signaling device, one said locating means being elevated relative to the other said locating means,

whereby in use placement of said signaling device at said one locating means indicates that attention of staff in a food or drink establishment is required.

The signalling and advertising device suitably comprises a display member for displaying advertising material and/or attracting wait staff, and an elongated member for carrying the display member. The locating means suitably comprise holes for receipt of an end of the elongated member to support the elongated member in an upright attitude, the stand including a planar base portion containing one hole and a tower portion extending from the base portion and containing another hole.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 illustrates the components of the signaling apparatus according to the present invention;

FIG. 2 is a longitudinal sectional view of the upper portion of the signaling device of the signaling apparatus; and.

FIGS. 3 and 4 illustrate the signaling apparatus in its two attitudes.

### DETAILED DESCRIPTION OF THE PREFERRED EMBODIMENT

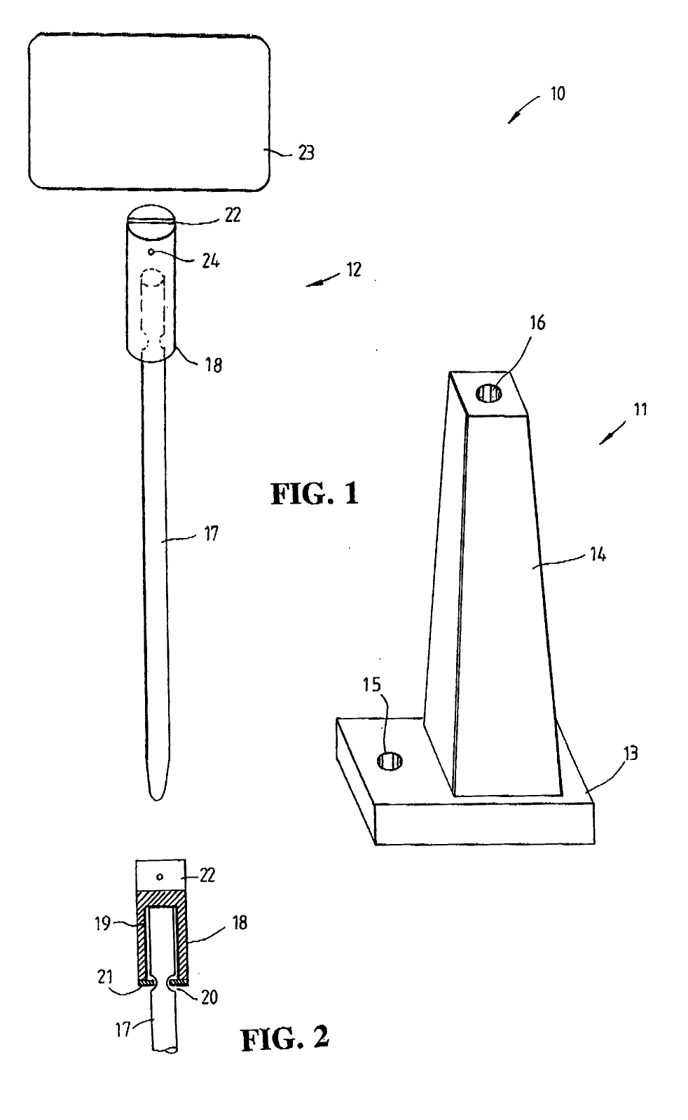

Referring to the drawings and firstly to FIGS. 1 and 2, there is illustrated the components of the signalling apparatus 10 according to the present invention including a support stand 11 and a signalling device 12 adapted to be supported on the stand 11. The stand 11 includes a base 13 which is of a generally planar configuration for seating on a support surface and an elongated tower-like portion 14 supported by the base 13 in a substantially upright attitude at an offset position on the base 13. The base 13 and tower portion 14 may be formed integrally or as separate components which are joined together. Preferably, the base and tower portions 13 and 14 are formed of timber however they may be formed of plastics or metal. Most preferably, the stand 11 has sufficient weight or is weighted to seat stably on a supporting surface.

The base 13 includes a centrally arranged aperture or hole 15 which when the stand 11 is seated on a horizontal surface is oriented substantially vertically. The tower portion 14 is also provided with an aperture or hole 16 at its upper end which is also oriented substantially vertically when the base 13 is seated on a horizontal surface.

The signalling device 12 includes an elongated member 17 which is of cylindrical rod-like form of slightly less diameter than the internal diameter of the apertures or holes 15 or 16. The upper end of the elongated member 17 is provided with a tubular or cylindrical sign holder 18 which is mounted for free rotation about the longitudinal axis of the elongated member 17. The holder 18 may be mounted by means of a suitable bearing arrangement to the end of the elongated member 17 but in a simplified form includes a blind bore or socket 19 of an internal diameter slighty greater than the diameter of the elongated member 17 (See FIG. 2) in which the upper end of the member 17 locates. To prevent or reduce the possibility of detachment of the holder 18 from the end of the elongated member 17, an annular groove 20 may be formed or provided in the elongated member 17 towards its upper end. The lower end of the holder 18 is provided with a washer 21 suitably a flexible washer fixed, such as by an adhesive, to the open end of the holder 18 and which has an internal diameter less than the diameter of the member 17 and which will thus locate within the groove 20 as shown in FIG. 2 when the holder 18 is in its operative position located over the end of the elongated member 17. The flexibility of the washer 21 allows the holder 18 to be forced over the end of the elongated member 17 until the washer 21 locates within the groove 19 to thereby capture the holder 18 to the elongated member 17 but permit is free rotation therearound.

The holder 18 is diametrically slit at 22 at its upper end to receive a planar card 23 such as a plastic point of sale card. The card 23 may be held in position by pinning at 24 through the holder 18. The 23 may carry any suitable advertising material such as advertising for a food product or beverage product such as wine or beer or any other product to be marketed such as a food special. The mounting of the holder 18 on the end of the elongated member 17 is such that when the card 23 is engaged with the holder 18, the holder 18 and card 23 may rotate or spin in for example windy conditions.

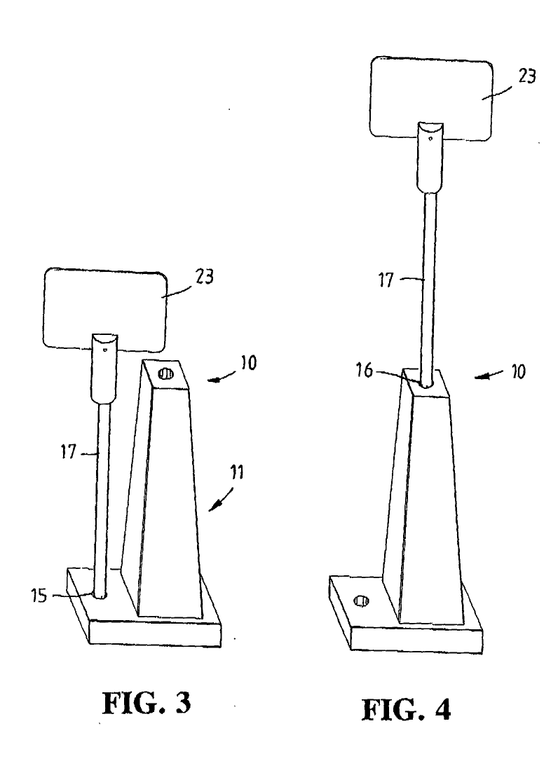

In use, the signalling apparatus 10 is placed on tables or the like in a restaurant. The elongated member 17 is normally located in the lowermost aperture 15 of the stand 11 as shown in FIG. 3. When the occupants of the table require service from staff in the restaurant, the member 17 is detached from the aperture 15 and inserted in the top aperture 16 as shown in FIG. 4 which substantially elevates the member 17 and card 23 which can be easily observed by the staff. When staff attend the table, the member 17 may be detached from the aperture 16 and replaced in the lower aperture 15. In either position, the card 23 is free to rotate with the holder 18. This will not only attract patrons to the card 23 and the message carried thereby such as advertising but will also substantially reduce the risk of the signalling apparatus 10 tipping over in the event of high winds.

The signalling apparatus 10 of course may be used in many different environments and may be used for advertising any product on the card 23. The signalling apparatus 10 may also be used to carry for example a table number on the card 23 of an establishment such that if food is ordered for a particular table, the table number as displayed by the card 23 when in the elevated position of FIG. 4 can be rapidly observed.

The components of the signalling apparatus 10 may be manufactured of any suitable material such as metal, plastics or wood or combinations thereof and of course may be in configurations other than that illustrated. For example, the stand 11 may be in the shape of a figure sculpture or in any other form.

Whilst the above has been given by way of illustrative embodiment of the invention, all such modifications and variations thereto as would be apparent to persons skilled in the art are deemed to fall within the broad scope and ambit of the invention as defined in the appended claims.

1. Signaling apparatus for use in restaurants or other establishments for attracting the attention of staff, said signaling apparatus comprising:
a signaling device;
a stand adapted to seat upon a table or other supporting surface, said stand having first and second locating means for said signaling device, one said locating means being elevated relative to the other said locating means,
whereby placement of said signaling device at said one locating means indicates that attention of staff is required.

2. Signaling apparatus as claimed in claim 1 wherein said signaling device comprises an elongated member, and wherein said locating means comprise means for supporting said elongated member in an upright attitude.

3. Signaling apparatus as claimed in claim 2 wherein said locating means comprise holes in said stand for receiving a lower end of said elongated member.

4. Signaling apparatus as claimed in claim 2 wherein said signaling device includes display or indicating means at an upper end of said elongated member.

5. Signaling apparatus as claimed in claim 4 wherein said display or indicating means is mounted rotatably at the upper end of said elongated member so as to be capable of free rotation about a substantially vertical axis.

6. Signaling apparatus as claimed in claim 4 wherein said display or indicating means comprises a planar display member and holder means for holding said display member.

7. Signaling apparatus as claimed in claim 6 wherein said holder comprises a cylindrical body, said body having at one end a diametrically extending slit for receipt and support of said planar display member.

8. Signaling apparatus as claimed in claim 6 wherein said holder includes a hollow socket for location over the upper end of said elongated member whereby said holder is supported for rotation relative to said elongated member.

9. Signaling apparatus as claimed in claim 8 and including means for capturing said holder to said upper end of said elongated member.

10. Signaling apparatus as claimed in claim 9 wherein said capturing means comprises a groove in said upper end of said elongated member and restraining means extending from said holder into said groove to restrain detachment of said holder from said elongated member.

11. Signaling apparatus as claimed in claim 1 wherein said stand includes a planar base portion containing one said locating means and a tower portion extending from said base portion and containing the other said locating means.

12. Signaling and advertising apparatus for use in food or drink establishments, said apparatus comprising:
a signaling and advertising device, said signaling and advertising device having means for displaying advertising material;
a stand adapted to seat upon a table or other supporting surface, said stand having first and second locating means for said signaling device, one said locating means being elevated relative to the other said locating means,
whereby in use placement of said signaling device at said one locating means indicates that attention of staff in said food or drink establishment is required.

13. Apparatus as claimed in claim 12 wherein said signalling and advertising device comprises a display member for displaying advertising material, and an elongated member for carrying said display member

14. Apparatus as claimed in claim 13 wherein said locating means comprise holes for receipt of said elongated member, said stand including a planar base portion containing one said hole and a tower portion extending from said base portion and containing another other said hole.
